(19) United States
(12) Patent Application Publication
(10) Pub. No.: US 2008/0132173 A1
(43) Pub. Date: Jun. 5, 2008

(54) CHANNEL ESTIMATION APPARATUS AND CHANNEL ESTIMATION METHOD

(75) Inventors: Dan Keun SUNG, Daejeon (KR); Junsu Kim, Daejeon (KR); Young-Jun Hong, Seoul (KR)

Correspondence Address: David A. Einhom, Esq.;Anderson Kill & Olick, P.C., 1251 Avenue of the Americas, New York, NY, 10020, US

(73) Assignee: KOREA ADVANCED INSTITUTE OF SCIENCE AND TECHNOLOGY, Daejon (KR)

(21) Appl. No.: 11/679,509

(22) Filed: Feb. 27, 2007

(30) Foreign Application Priority Data
Nov. 30, 2006 (KR) 10-2006-0120033

(51) Int. Cl. H04B 17/00

(52) U.S. Cl. 455/67.13

(57) ABSTRACT

Channel state indication signals are transmitted to communication stations via wireless channels and SINR (Signal to Interference and Noise Ratio) values of the channel state indications signals or channel environment parameters according to the SINR values are received from the communication stations as feedback signals. A channel estimation apparatus includes: an average measurement unit for measuring average values of the feedback signals over a period of time, each of the average values being an average value of feedback signals received from an identical communication station during the period of time; and a channel evaluation unit for estimating wireless channel quality of each communication station according to a geographical environment thereof based on the average values measured by the average measurement unit.

### FIELD OF THE INVENTION

The present invention relates to estimation of a wireless channel in a mobile communication system, and more particularly, to an apparatus and method for estimating a wireless channel environment using a channel state indication signal, and a mobile communication system employing the same.

### BACKGROUND OF THE INVENTION

As shown in FIG. 1, a typical mobile communication system includes a home location register 10, a mobile switching center 20, a base station 30, and a plurality of mobile terminals 40.

The home location register 10 stores therein profile information of the mobile terminals 40 and also receives location information of each mobile terminal 40 to perform a location update thereof.

The mobile switching center 20 performs a basic and additional service processing, a call processing for a call to or from a subscriber, a location registration, an inter-cell handover determination, an interworking with other networks, and so on.

The base station 30 builds wireless access networks with the mobile terminals 40 to guarantee wireless communications of the mobile terminals 40, and performs a scheduling and a wireless resource management. Further, the base station 30 performs a baseband signal processing, a wired-to-wireless switching, a wireless signal transmission and reception, a wireless channel assignment and release to and from the mobile terminals 40, a handover processing, a transcoding and vocoding, a GPS (Global Positioning System) clock distribution, and the like.

The mobile terminal 40 enables a user to perform voice and data communications over mobile communications networks.

A communications process between the base station 30 and the plurality of mobile terminals 40 in the above-described mobile communication system is as follows.

First, when the base station 30 transmits a pilot signal 51 or 52, the mobile terminal 40 receives the pilot signal to measure an SINR (Signal to Interference and Noise Ratio). The mobile terminal 40 then transmits a feedback signal 61 or 62 to the base station 30 based on the measured SINR.

A role and a type of the feedback signal 61 or 62 are dependent on a system. In a CDMA (Code Division Multiple Access) system for voice information transmission, the mobile terminal 40 transmits a power control signal as the feedback signal 61 or 62. On the other hand, in a scheduling system for high-speed data transmission in a downlink, the mobile terminal 40 transmits wireless channel information for use with AMC (Adaptive Modulation and Coding) as the feedback signal 61 or 62.

The mobile terminal 40 may transmit the measured SINR or a specific integer value as a feedback signal 61 or 62 to the base station 30 depending on settings of system. For example, in a HSDPA (High-Speed Downlink Packet Access) and 1xEV-DO systems, a specific integer value, which is an AMC parameter corresponding to the measured SINR, is transmitted to the base station 30. On the other hand, in WiBro (Mobile WiMAX) and IEEE 802.16e systems, an average and a standard deviation of the measured SINR are transmitted to the base station 30.

The base station 30 uses the feedback signal 61 or 62 received from the mobile terminal 40 to perform power control or adaptive modulation and coding.

Meanwhile, according to features of the feedback signal, mobile communication systems may be classified into a system in which a specific integer corresponding to a measured SINR value is fed back, and a system in which a measured SINR value itself is fed back.

FIG. 2 is a partial configuration view showing a mobile communication system in which a specific integer corresponding to an SINR value is fed back according to a conventional technique, and FIG. 3 is a partial configuration view showing a mobile communication system in which an SINR value itself is fed back according to another conventional technique.

In the mobile communication system shown in FIG. 2, an AMC parameter selecting unit 43 of a mobile terminal 40 selects an AMC parameter corresponding to an SINR value measured by an SINR measuring unit 41 and feeds it back to a base station 30. On the other hand, in the mobile communication system shown in FIG. 3, an SINR value measured by an SINR measuring unit 41′ of a mobile terminal 40′, instead of an AMC parameter, is fed back to a base station 30.

The base station 30 includes a memory 31 for storing therein user data received from the mobile terminal 40 or 40′. Further, a scheduler 33 in the base station 30 selects the mobile terminal 40 or 40′ to be served next to the mobile terminal 40 or 40′ presently served based on the AMC parameter or the SINR value received from the terminal 40 or 40′. Data on the selected mobile terminal 40 or 40′ is subject to physical layer processing and then transmitted together with a pilot signal 35 to the mobile terminal 40 or 40′ via a wireless channel. Upon receipt of the signal, the mobile terminal 40 or 40′ measures an SINR using the received pilot signal and then transmits either an AMC parameter selected, based on the SINR value measured, for indicating a wireless channel state or the measured SINR value itself to the base station 30. The signal transmission and reception processes are repeatedly performed.

However, such conventional techniques have a limitation on extracting information from a pilot signal and feedback signals corresponding thereto, which are exchanged between the mobile terminal and the base station, so that wireless channel environment information cannot be fully utilized.

In particular, since wireless channel environment information is managed in a mobile switching center rather than the base station while the scheduler in the base station performs a wireless scheduling by using the wireless channel environment information, it is difficult to increase the accuracy of wireless scheduling due to, for example, transmission delay in communications between the base station and the mobile switching center.

### SUMMARY OF THE INVENTION

It is, therefore, an object of the present invention to provide an apparatus and method capable of estimating a channel environment dependent on a geographical environment from feedback signals, which have channel environment parameter values corresponding to measured SINR values, and which are provided by a mobile terminal, and a mobile communication system employing the same.

Another object of the present invention is to provide an apparatus and method capable of estimating a channel environment dependent on a geographical environment from feedback signals, which contain measured SINR values themselves and which are provided by a mobile terminal, and a mobile communication system employing the same.

Still another object of the present invention is to provide an apparatus and method capable of estimating an overall wireless channel environment by estimating channel environments dependent on a geographical environment and mobility from feedback signals, which contain channel environment parameter values corresponding to measured SINR values and which are provided by a mobile terminal, and a mobile communication system employing the same.

Still another object of the present invention is to provide an apparatus and method capable of estimating an overall wireless channel environment by estimating channel environments dependent on a geographical environment and mobility from feedback signals, which contain measured SINR values themselves and which are provided by a mobile terminal, and a mobile communication system employing the same.

In accordance with a first aspect of the present invention, there is provided a channel estimation apparatus, wherein channel state indication signals are transmitted to communication stations via wireless channels and SINR (Signal to Interference and Noise Ratio) values of the channel state indications signals or channel environment parameters according to the SINR values are received from the communication stations as feedback signals, the apparatus including:

an average measurement unit for measuring average values of the feedback signals over a period of time, each of the average values being an average value of feedback signals received from an identical communication station during the period of time; and

a channel evaluation unit for estimating wireless channel quality of each communication station according to a geographical environment thereof based on the average values measured by the average measurement unit.

In accordance with a second aspect of the present invention, there is provided a channel estimation apparatus, including:

an average measurement unit for measuring an average value of pilot signals over a period of time, the pilot signals being SINR (Signal to Interference and Noise Ratio) values of channel state indication signals received from a communication station via a wireless channel during the period of time or channel environment parameters according to the SINR values; and

a channel evaluation unit for estimating wireless channel quality according to a geographical environment based on the average values measured by the average measurement unit.

In accordance with a third aspect of the present invention, there is provided a channel estimation method, including the steps of:

(a) measuring an average value of pilot signals over a period of time, the pilot signals being SINR (Signal to Interference and Noise Ratio) values of channel state indication signals received from a communication station via a wireless channel during the period of time or channel environment parameters according to the SINR values; and

(b) estimating wireless channel quality according to a geographical environment based on the average values measured in step (a).

In accordance with a fourth aspect of the present invention, there is provided a channel estimation method, including the steps of:

(a) measuring an average value of pilot signals over a period of time, the pilot signals being SINR (Signal to Interference and Noise Ratio) values of channel state indication signals received from a communication station via a wireless channel during the period of time or channel environment parameters according to the SINR values; and

(b) estimating wireless channel quality according to a geographical environment based on the average values measured in step (a).

### BRIEF DESCRIPTION OF THE DRAWINGS

The above and other objects and features of the present invention will become apparent from the following description of embodiments given in conjunction with the accompanying drawings, in which:

FIG. 1 shows a conceptual diagram of a typical mobile communication system;

FIG. 2 shows a diagram illustrating a partial configuration of a mobile communication system according to is a conventional technique;

FIG. 3 shows a diagram illustrating a partial configuration of a mobile communication system according to another conventional technique;

FIGS. 4A and 4B show a partial configuration of a mobile communication system and a channel estimation apparatus, respectively, according to a first embodiment of the present invention;

FIGS. 5A and 5B show a partial configuration of a mobile communication system and a channel estimation apparatus, respectively, according to a second embodiment of the present invention;

FIG. 6 shows a classification of wireless channel environments based on a geographical environment in a wireless channel estimation method according to the present invention;

FIGS. 7A and 7B show a partial configuration of a mobile communication system and a channel estimation apparatus, respectively, according to a third embodiment of the present invention;

FIGS. 8A and 8B show a partial configuration of a mobile communication system and a channel estimation apparatus, respectively, according to a fourth embodiment of the present invention;

FIG. 9 shows a classification of wireless channel environments based on mobility in the wireless channel estimation method according to the present invention;

FIG. 10 shows a classification of wireless channel environments based on both of a geographical environment and mobility in the wireless channel estimation method according to the present invention;

FIGS. 11A and 11B show a partial configuration of a mobile communication system and a channel estimation apparatus, respectively, in accordance with an extended embodiment of the present invention; and

FIG. 12 shows a channel estimation apparatus in accordance with another extended embodiment of the present invention

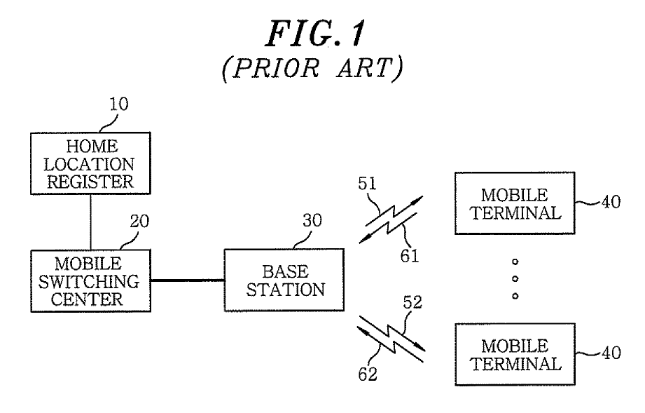

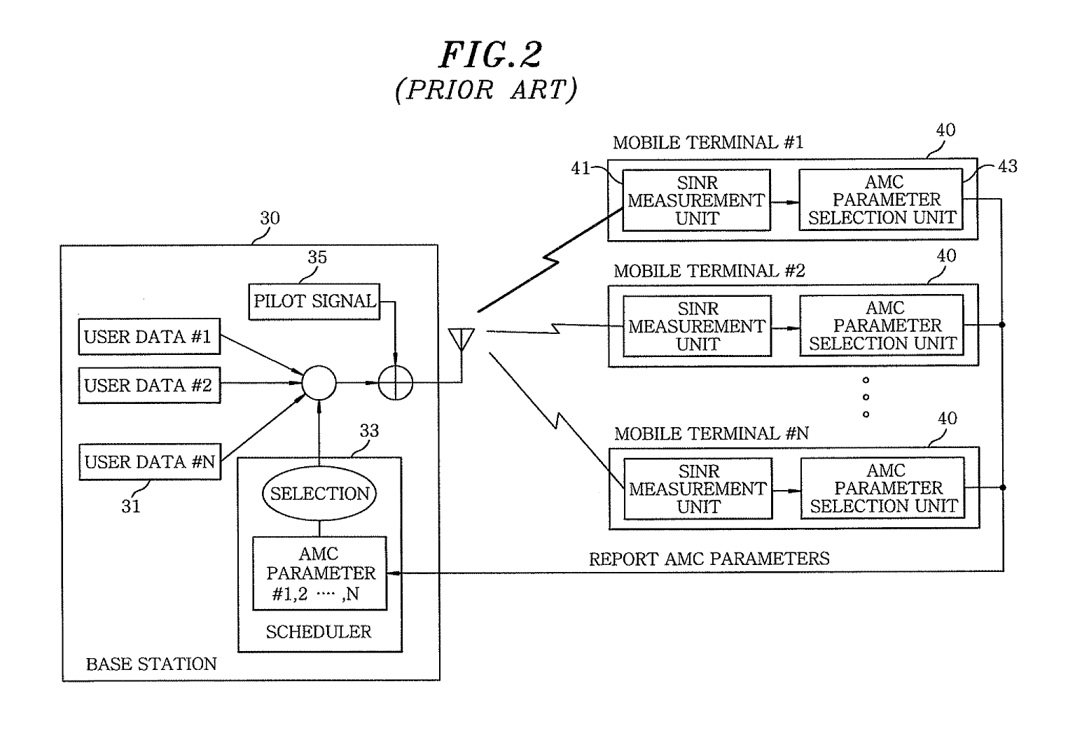

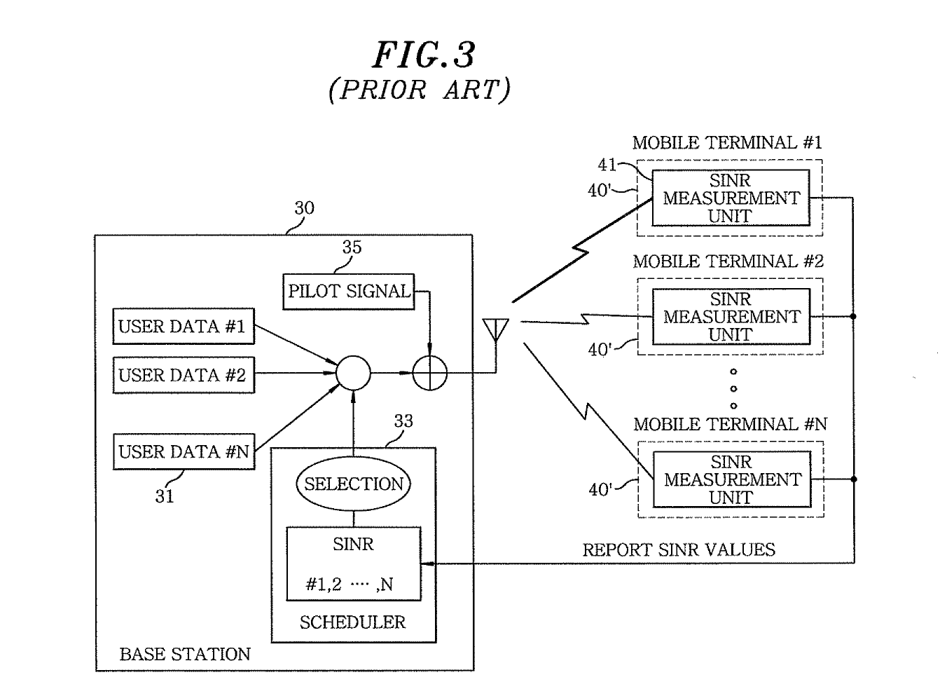

### DETAILED DESCRIPTION OF THE EMBODIMENTS

Hereinafter, embodiments of the present invention will be described in detail with reference to the accompanying drawings so that they can be readily implemented by those skilled in the art.

Although a pilot signal is employed as a signal indicating a channel state in describing the following embodiments in connection with a typical mobile communication system, any other signal may be employed only if the signal indicates the channel state. Furthermore, although a base station and mobile terminals are selected as communication stations, the base station and the mobile terminals are only examples of communication stations transmitting and receiving the channel state indication signal in a typical mobile communication system.

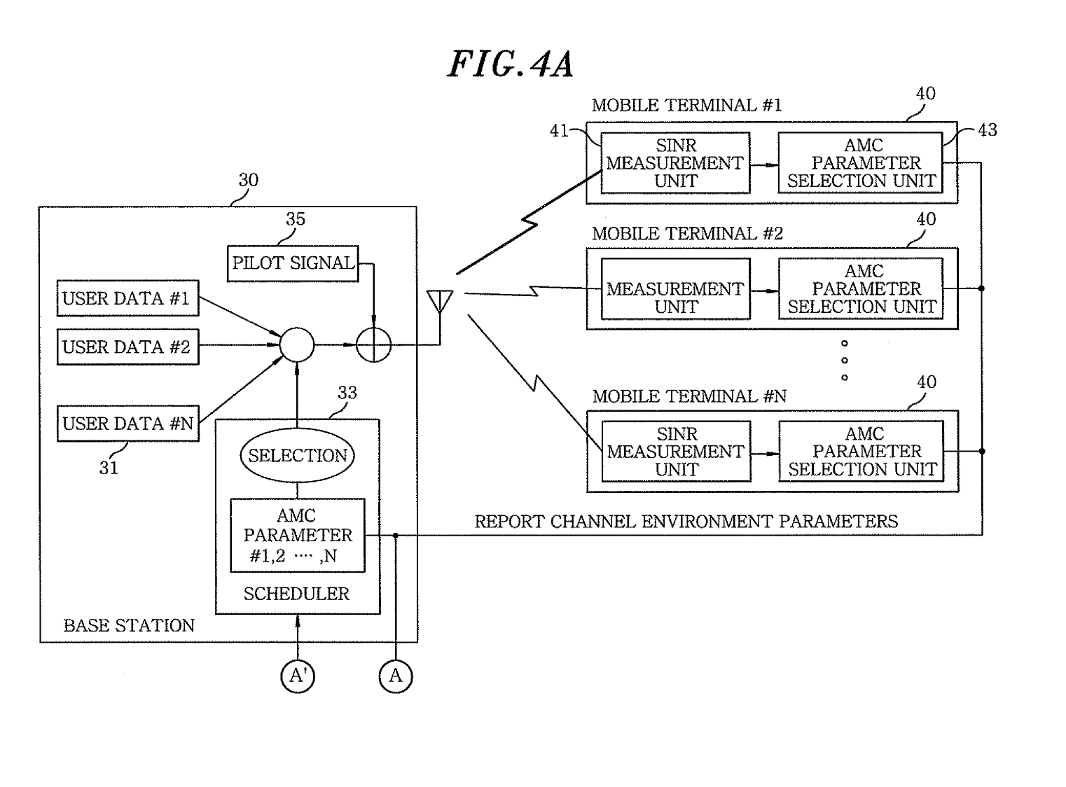

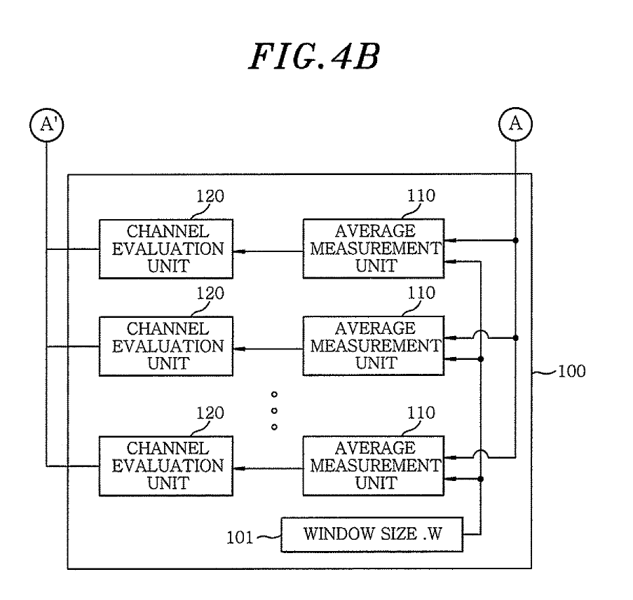

FIGS. 4A and 4B show a partial configuration of a mobile communication system and a channel estimation apparatus, respectively, according to the first embodiment of the present invention.

Referring to FIGS. 4A and 4B, the mobile communication system includes a base station 30 for transmitting a pilot signal; mobile terminals 40, each for receiving the pilot signal and transmitting a channel environment parameter value converted from a measured SINR value as a feedback signal; and a channel estimation apparatus 100 for estimating channel quality of each of the mobile terminals 40 according to a geographical environment thereof based on the channel environment parameter serving as a feedback signal.

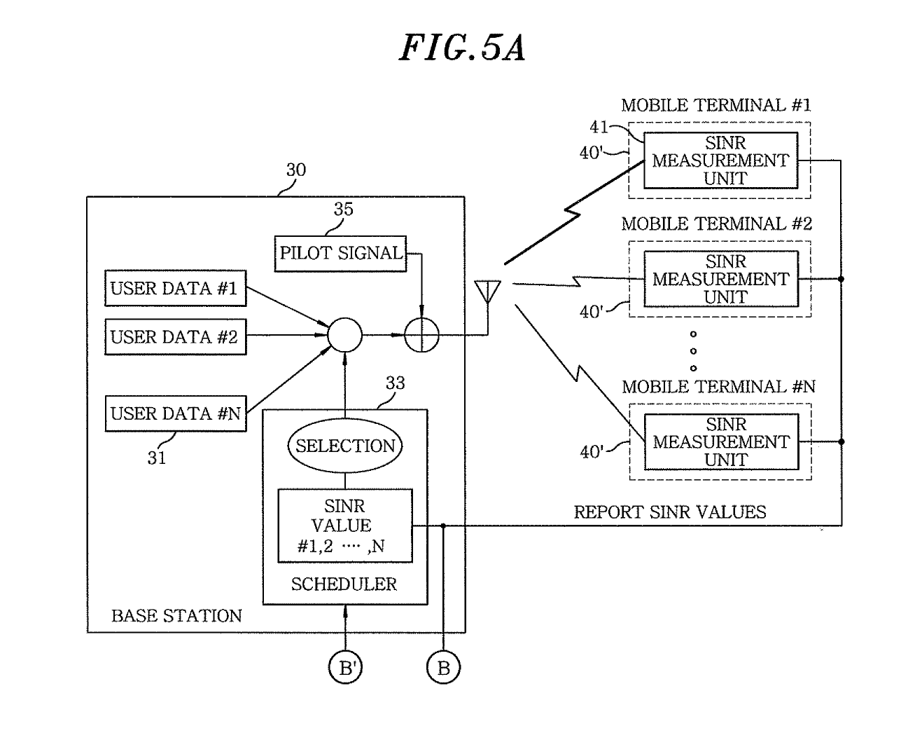

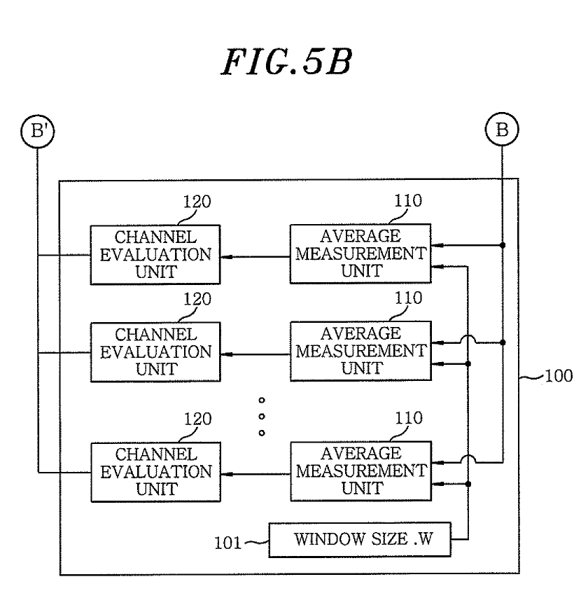

FIGS. 5A and 5B show a partial configuration of a mobile communication system and a channel estimation apparatus, respectively, according to the second embodiment of the present invention.

Referring to FIGS. 5A and 5B, a mobile communication system includes a base station 30 for transmitting a pilot signal; mobile terminals 40′, each for receiving the pilot signal and transmitting a measured SINR value; and a channel estimation apparatus 100 for estimating channel quality of each of the mobile terminals 40′ according to a geographical environment thereof based on the SINR value serving as a feedback signal.

In the base station 30, a memory 31 stores therein user data received from the mobile terminals 40 or 40′. A scheduler 33 in the base station 30 selects a mobile terminal 40 or 40′ to be served next to the mobile terminal 40 or 40′ being served presently, based on the channel environment parameter or SINR value received from the mobile terminals 40 or 40′. The data for the selected mobile terminal 40 or 40′ is subject to a physical layer processing and transmitted together with the pilot signal 35 to the mobile terminal 40 or 40′ via a wireless channel. Upon receipt of the signal, the mobile terminal 40 or 40′ measures the SINR of the received pilot signal, and selects a channel environment parameter suitable for a wireless channel state based on the SINR value. The mobile terminal 40 or 40′ transmits either the channel environment parameter or the measured SINR value itself to the base station 30. Such signal transmission and reception process is repeatedly performed.

The feedback signal, which contains information such as the channel state parameter value or the measured SINR value and is transmitted from the terminal 40 or 40′, varies with the mobile communication system. The channel environment parameter of the present invention is CSI (Channel State Information) containing physical layer packet size, transmission time, and preamble size, such as a CQI (Channel Quality Indicator) of the HSDPA or a DRC (Data Rate Control) of the 1xEV-DO for determining an MCS (Modulation and Coding Scheme) value. That is, the channel environment parameter according to the present invention is any feedback signal capable of determining a coding rate and a modulation scheme for data transmission. For example, there are 30 downlink channel environment parameter values in the HSDPA, and 36 downlink channel environment parameter values in the 1xEV-DO Rev. A.

In the standard of the HSDPA which is a representative system feeding back the channel environment parameters, the channel environment parameter corresponds to the CQI value. In case of the 1xEV-DO, since channel environment parameters do not correspond to specific values, in order to apply the present invention thereto, downlink channel environment parameters are required to correspond to specific values. Accordingly, DRC values are added to a content of an existing standardized document, as shown in Table 1.

In Table 1, physical layer packet size is the total size of a packet (in bits) that can be transmitted at a time on the physical layer and nominal transmit duration indicates the time duration required for transmitting the physical layer packet. Further, preamble is a control signal for synchronizing a transmitting side with a receiving side, and its length may increase as channel quality is degraded. These parameters are used in determining a coding rate and modulation scheme for data transmission.

Through the above-described correspondence, the channel environment parameters (such as the CQI in the HSDPA, the DRC in the 1xEV-DO or the like) correspond to the greater value as a data rate increases. Further, when the mobile terminal 40 selects a channel environment parameter with a great value, it means that the wireless channel state is relatively good. Accordingly, the channel environment parameter is another representation of the measured SINR value.

TABLE 1

| | Physical Layer | Nominal Transmit | Preamble |
|---|---|---|---|
| DRC Value | Packet Size (bits) | Duration (slots) | Length (chips) |
| 1 | 128 | 16 | 1024 |
| 2 | 128 | 8 | 512 |
| 3 | 128 | 4 | 1024 |
| 4 | 128 | 4 | 256 |
| 5 | 128 | 2 | 128 |
| 6 | 128 | 1 | 64 |
| 7 | 256 | 16 | 1024 |
| 8 | 256 | 8 | 512 |
| 9 | 256 | 4 | 1024 |
| 10 | 256 | 4 | 256 |
| 11 | 256 | 2 | 128 |
| 12 | 256 | 1 | 64 |
| 13 | 512 | 16 | 1024 |
| 14 | 512 | 8 | 512 |
| 15 | 512 | 4 | 1024 |
| 16 | 512 | 4 | 256 |
| 17 | 512 | 4 | 128 |
| 18 | 512 | 2 | 128 |
| 19 | 512 | 2 | 64 |
| 20 | 512 | 1 | 64 |
| 21 | 1024 | 16 | 1024 |
| 22 | 1024 | 8 | 512 |
| 23 | 1024 | 4 | 256 |
| 24 | 1024 | 4 | 128 |
| 25 | 1024 | 2 | 128 |
| 26 | 1024 | 2 | 64 |
| 27 | 1024 | 1 | 64 |
| 28 | 2048 | 4 | 128 |
| 29 | 2048 | 2 | 64 |
| 30 | 2048 | 1 | 64 |
| 31 | 3072 | 2 | 64 |
| 32 | 3072 | 1 | 64 |
| 33 | 4096 | 2 | 64 |
| 34 | 4096 | 1 | 64 |
| 35 | 5120 | 2 | 64 |
| 36 | 5120 | 1 | 64 |

In the channel estimation apparatus 100, the average measurement unit 110 measures the average of the received feedback signal strength in order to measure the channel quality according to geographical factors of the mobile terminal 40 or 40′ and then provides the average to the channel evaluation unit 120. The average is calculated as a weighted moving average with a window size 101 of W. That is, the channel estimating apparatus 100 estimates the channel environment according to a geographical environment of the mobile terminal 40 or 40′ by using statistical information of channel environment parameter or SINR value fed back from the mobile terminal 40 or 40′.

The channel environment parameter and the SINR value are indices indicating whether the wireless channel state is good or bad, and main factors in determining them include the moving speed of the mobile terminal 40 or 40′, the distance from the mobile terminal 40 or 40′ to the base station 30 and geographical information such as geographical features surrounding the mobile terminal 40 or 40′ and the like. In the present embodiment, the geographical environment of the mobile terminal 40 or 40′ are estimated for estimating wireless channel environment.

As the mobile terminal 40 or 40′ goes away from the base station 30 or is surrounded by more mountains, hills or buildings, the channel environment parameter or the SINR value becomes smaller. Thus, by measuring the channel environment parameter or SINR value fed back from the mobile terminal 40 or 40′, geographical information of the mobile terminal 40 or 40′ can be obtained. That is, the geographical information of the mobile terminal 40 or 40′ is estimated by measuring the weighted moving average of the fed-back SINR value or channel environment parameter.

If the SINR value or channel environment parameter fed back from the n-th mobile terminal 40 or 40′ is Yₙ, the average value E[Yₙ] represents the distance from the mobile terminal 40 or 40′ and the base station 30 and information on geographical features. When there are no geographical features between the mobile terminal 40 or 40′ and the base station 30, the average value represents only the distance information. Further, change of channels over time is not independent, but a channel state at the current time is highly correlated with the channel state at the nearest past. Accordingly, E[Yₙ] is measured by assigning a relatively high weight to recent Yₙ. In this case, W, which is the window size 101 for determining a range of past values to be considered for measurement, can be freely adjusted by a system operator.

In this manner, relative geographical information of each mobile terminal 40 or 40′ can be estimated by using the average value of the feedback signal. That is, the channel estimation apparatus 100 can estimate the relative quality of a given wireless channel according to the geographical environment by measuring the average values E[Yₙ] of the feedback signals received from the mobile terminals 40 or 40′ and comparing the values with each other.

On the other hand, as shown in FIGS. 4A to 5B, the channel evaluation unit 120 in the channel estimation apparatus 100 obtains information on characteristics of the wireless channel environment between the mobile terminal 40 or 40′ and the base station 30, and sends the information to the scheduler 33 in the base station 30. The scheduler 33 selects a mobile terminal 40 or 40′ to be served next to the mobile terminal 40 or 40′ being served by using the information on the wireless channel environment received from the channel evaluation unit 120.

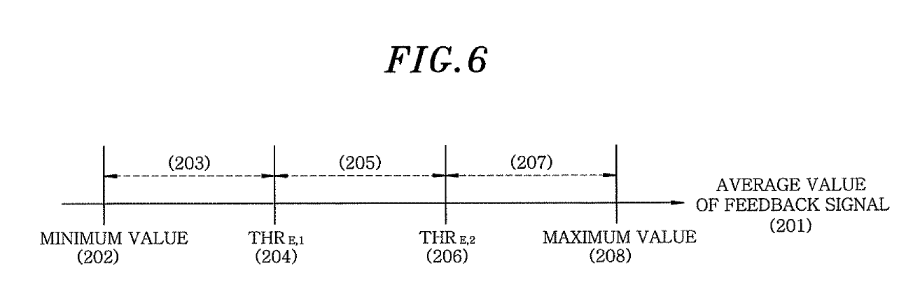

FIG. 6 is shows a classification of wireless channel environments based on a geographical environment in a wireless channel estimation method according to the present invention.

In the channel estimation apparatus 100, the channel evaluation unit 120 classifies the range of the average value E[Yₙ] of the feedback signal measured by the average measurement unit 110 into a plurality of sections and utilizes each section as an index indicating the quality of a given wireless channel environment according to a geographical environment of the mobile terminal 40 or 40′. For example, when the range of average value 201 of the feedback signal between its minimum and maximum value 202 and 208 is divided into a first to a third section 203 to 207 and boundary values 204 and 206 between the respective sections are THR_{E,1} and THR_{E,2}, the respective section 203 to 207 become indices indicating the quality of a given wireless channel environment according to the geographical environment of the mobile terminal 40 or 40′. As the average value E[Yₙ] of the feedback signal from the n-th mobile terminal 40 or 40′ increases, the geographical environment of the mobile terminal 40 or 40′ becomes better. Accordingly, the signal is highly attenuated in an area corresponding to the first section 203, the signal is moderately attenuated in an area corresponding to the second section 205, and the signal is less attenuated in an area corresponding to the third section 207. The use of the above-described channel evaluation method allows estimation of the geographical environments of all the mobile terminals 40 and 40′.

In this manner, the channel estimation apparatus 100 can easily estimate the wireless channel environment according to the geographical environment of the mobile terminal 40 or 40′, and the base station 30 can easily perform wireless resource assignment, handover, scheduling, and so on by using the estimation result without consuming a limited resource of the mobile terminal 40 or 40′.

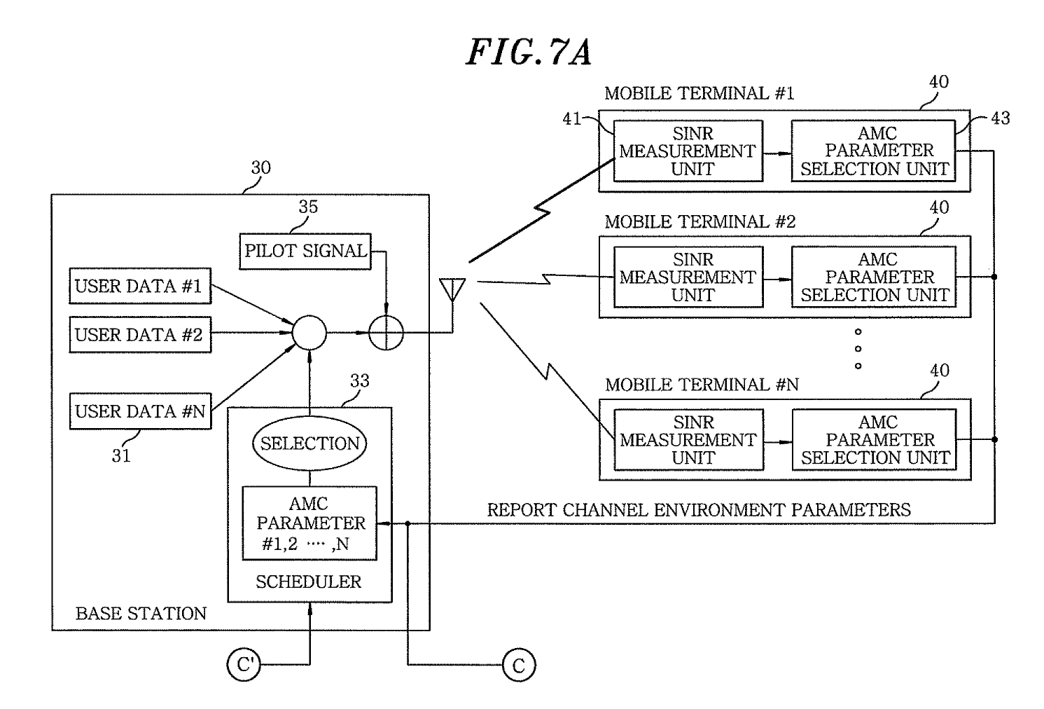

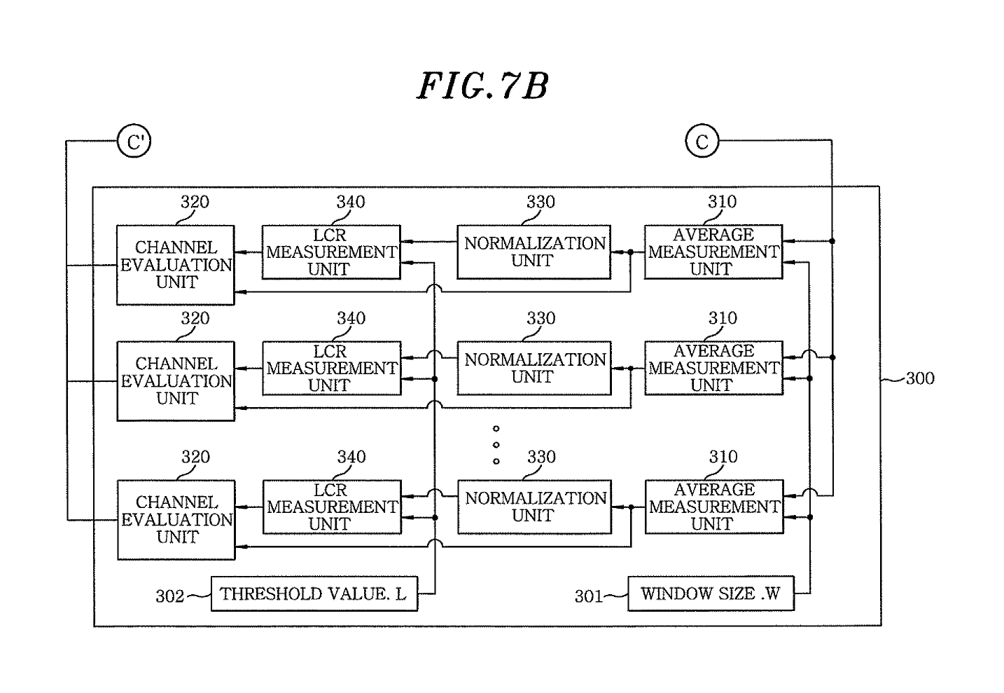

FIGS. 7A and 7B show a partial configuration of a mobile communication system and a channel estimation apparatus, respectively, according to the third embodiment of the present invention.

Referring to FIGS. 7A and 7B, the mobile communication system to which the channel estimation apparatus is applied includes a base station 30 for transmitting a pilot signal; mobile terminals 40 for receiving the pilot signal and transmitting, as a feedback signal, a channel environment parameter value converted from a measured SINR value; and a channel estimation apparatus 300 for estimating an overall wireless channel environment by estimating channel environments according to a geographical environment and mobility based on the channel environment parameter serving as a feedback signal.

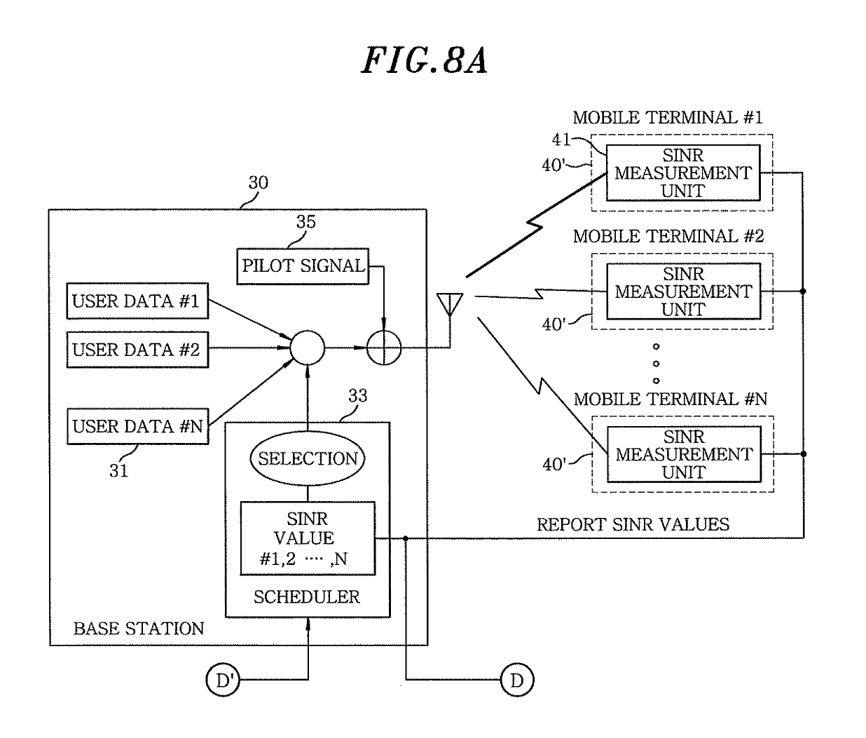

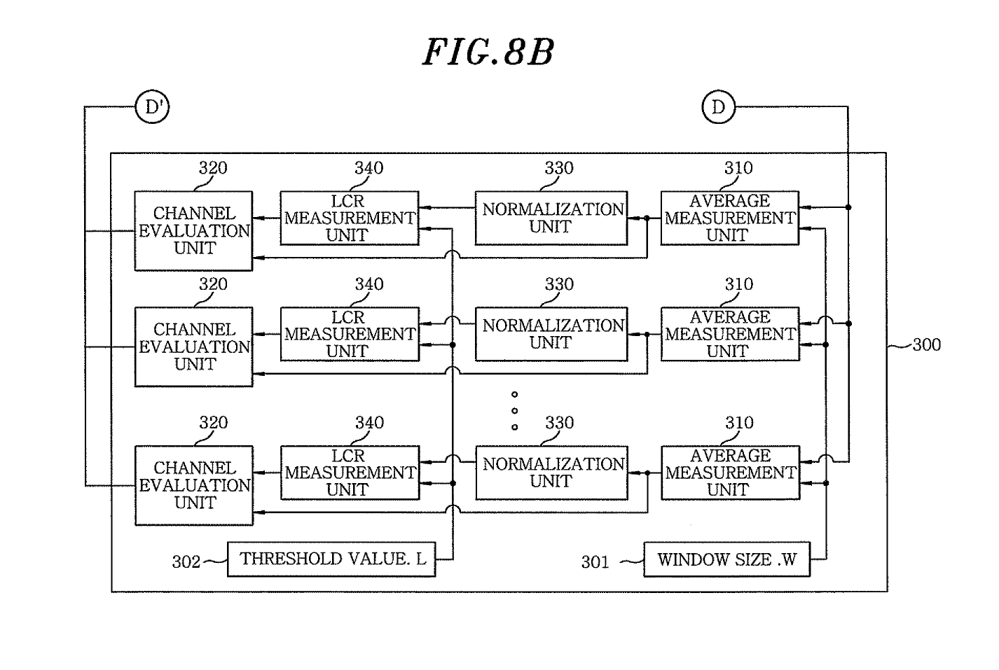

FIGS. 8A and 8B show a partial configuration of a mobile communication system and a channel estimation apparatus, respectively, according to the fourth embodiment of the present invention.

Referring to FIGS. 8A and 8B, the mobile communication system to which the channel estimation apparatus is applied includes a base station 30 for transmitting a pilot signal; mobile terminals 40′ for receiving the pilot signal and transmitting a measured SINR value as a feedback signal; and a channel estimation apparatus 300 for estimating an overall wireless channel environment by estimating channel environments according to a geographical environment and mobility from the SINR value serving as a feedback signal.

A description of the same portions of the channel estimation apparatus in accordance with the third and fourth embodiments of the present invention as those of the channel estimation apparatus in accordance with the first and second embodiments of the present invention (i.e., details of the base station 30, the mobile terminal 40 or 40′, the channel environment parameters, etc.) will be omitted.

In the channel estimation apparatus 300, in order to measure channel quality according to geographical factors of the mobile terminal 40 or 40′, the average measurement unit 310 measures the average of the received feedback signal strength and provides the average to the channel evaluation unit 320. The average is a weighted moving average with a window size 301 of W. That is, the channel estimation apparatus 300 estimates the channel environment according to a geographical environment of the mobile terminal 40 or 40′ by using statistical information on channel environment parameter or SINR value fed back from the mobile terminal 40 or 40′.

The channel environment parameter and the SINR value are indices indicating whether the wireless channel state is good or bad, and main factors in determining them include the moving speed of the mobile terminal 40 or 40′, the distance from the mobile terminal 40 or 40′ to the base station 30, and geographical information such as geographical features surrounding the mobile terminal 40 or 40′. The moving speed of the mobile terminal 40 or 40′ causes a change in the SINR value measured by the channel estimation apparatus 300, and the geographical information of the mobile terminal 40 or 40′ causes the varying magnitude of the SINR value measured by the channel estimation apparatus 300.

As the mobility of the mobile terminal 40 or 40′ increases, the channel varies more and the SINR value and the channel environment parameter value rapidly vary. Furthermore, as the mobile terminal 40 or 40′ goes away from the base station 30 or is surrounded by more mountains, hills or buildings, the channel environment parameter and the SINR value become smaller. Thus, by measuring the magnitude and change of the channel environment parameter or SINR value fed back from the mobile terminal 40 or 40′, the mobility and geographical information of the mobile terminal 40 or 40′ can be obtained.

The geographical information of the mobile terminal 40 or 40′ is estimated by measuring average values of the feedback SINR value or channel environment parameter over time. The estimation of the relative quality of the wireless channel according to the geographical environment in the channel estimation apparatus 300 has been described in detail in the first and second embodiments of the present invention, and thus a description thereof will be omitted.

A wireless fading channel is configured with a multiplication of a geographical-environment-dependent factor (i.e., path loss according to the distance and the shadowing according to surrounding geographical features) by a mobility-dependent factor of the mobile terminal 40 or 40′. Since the channel environment according to the geographical environment can be estimated in the above-described manner, the feedback signal from the mobile terminal 40 or 40′ is divided by the geographical-environment-dependent factor in estimating the channel environment according to the mobility of the mobile terminal 40 or 40′. Such process is defined as a normalization process. To be specific, the normalization process is defined as Equation 1:

$${Z}_{n} = \frac{{Y}_{n}}{E [ {Y}_{n} ]} , \qquad Equation 1$$

wherein Zₙ denotes the normalized feedback signal from the n-th mobile terminal 40 or 40′

The normalization process of Equation 1 is performed by the normalization unit 330 of the channel estimation apparatus 300. Through the normalization process, the normalized feedback signal Zₙ contains only the information on the mobility excluding the geographical information of the mobile terminal 40 or 40′.

Next, an LCR (Level Crossing Rate) measurement scheme is used to estimate the mobility of the mobile terminal 40 or 40′. The LCR indicates how many times a specific signal crosses a specific value per unit time. In this case, the number is counted only when the signal crosses a threshold value in the positive direction. That is, the number is counted only when the signal crosses the threshold value in one direction. On the other hand, the number may be counted only when the signal crosses from a greater value than the threshold value to a smaller value than the threshold value

The LCR measurement unit 340 for processing the LCR measurement scheme sets a specific real number L to a threshold value 302 in order to measure the LCR of the normalized feedback signal Zₙ. The threshold value L can be any real number value. Even if the moving speed of the n-th mobile terminal 40 or 40′ is constant, the LCR of Zₙ varies according to the threshold value L. Accordingly, the best performance in the estimation of the mobility of the mobile terminal 40 or 40′ can be achieved by determining a threshold value L to obtain the highest LCR at the same moving speed. Preferably, the threshold value L is set to 0.5.

After the LCR of the normalized feedback signal of each mobile terminal 40 or 40′ is measured, the channel evaluation unit 120 can estimate the relative mobility of each mobile terminal 40 or 40′. That is, when the LCR of the normalized feedback signal of each mobile terminal 40 or 40′ is received from the LCR measurement unit 340, the channel evaluation unit 120 compares the values with each other to estimate the relative quality of the wireless channel according to the mobility of each mobile terminal 40 or 40′.

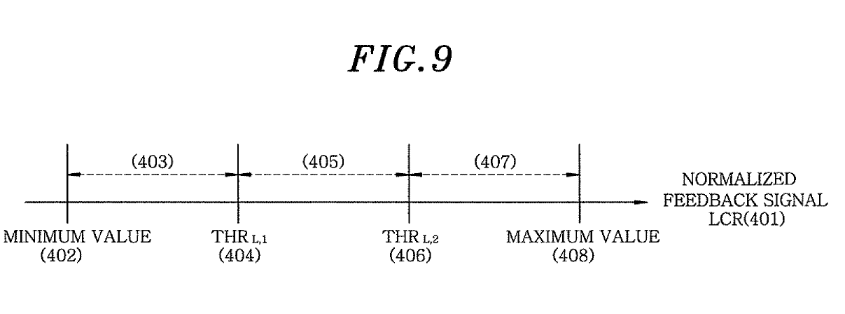

FIG. 9 shows a classification of wireless channel environments based on mobility in the wireless channel estimation method according to the present invention

In the channel estimation apparatus 300, the channel evaluation unit 320 divides the range of the LCR of the normalized feedback signal of the mobile terminal 40 or 40′ into a plurality of sections and utilizes each section as an index indicating the quality of the wireless channel environment according to the mobility of the mobile terminal 40 or 40′. For example, when the range of an LCR value 401 of the feedback signal between its minimum and maximum value 402 and 408 is classified into a first to a third section 403 to 407 and boundary values 404 and 406 between the respective sections are THR_{L,1} and THR_{L,2}, the respective section 403 to 407 become indices indicating the quality of a wireless channel environment according to the mobility of the mobile terminal 40 or 40′. That is, as the LCR of the normalized feedback signal of the mobile terminal 40 or 40′ is smaller, the moving speed of the mobile terminal 40 or 40′ becomes lower and, accordingly, the wireless channel environment according to the mobility becomes better. Accordingly, the mobility is low in the area corresponding to the first section 403, the mobility is moderate in the area corresponding to the second section 405, and the mobility is high in the area corresponding to the third section 407. The use of such channel evaluation method allows estimation of wireless environment according to the mobility of all the mobile terminals 40 and 40′

Next, the channel evaluation unit 320 of the channel estimation apparatus 300 estimates the overall wireless channel environment of the mobile terminal 40 or 40′ by using the estimation result of the wireless channel environment according to the geographical environment and the estimation result of the wireless channel environment according to the mobility.

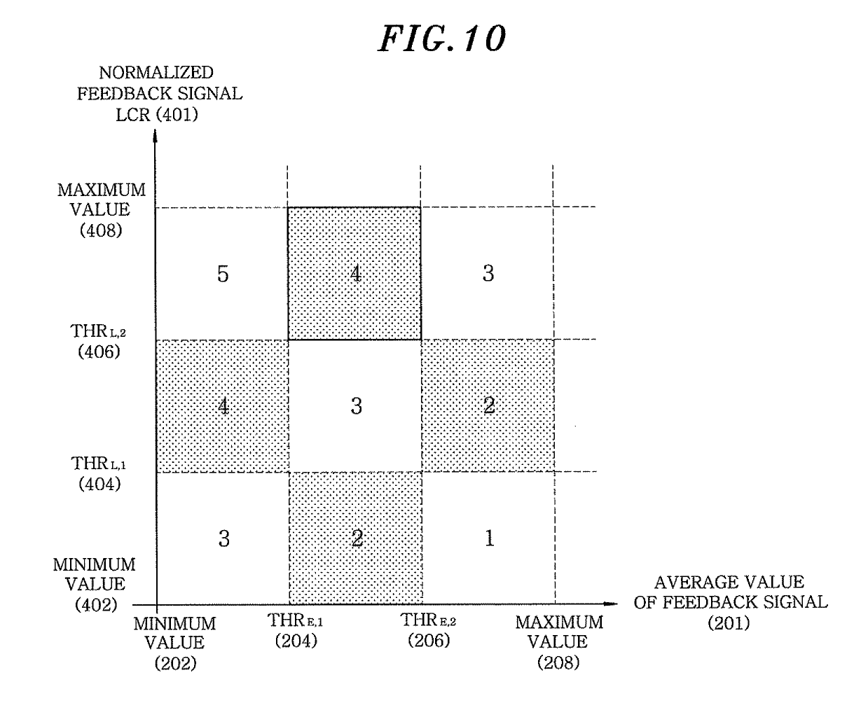

FIG. 10 shows a classification of wireless channel environment based on both of a geographical environment and mobility in the wireless channel estimation method according to the present invention. In order to estimate the overall wireless channel environment of the mobile terminal 40 or 40′ in two dimensions, the average value 201 of the feedback signal, which is the index of the wireless channel environment according to the geographical environment as shown in FIG. 6, is set on the x axis, and the LCR 401 of the normalized feedback signal, which is the index of the wireless channel environment according to the mobility as shown in FIG. 9, is set on the y axis.

In the channel estimation apparatus 300, the channel evaluation unit 320 divides the x and the y axes into k sections, respectively, to divide the plane into k×k areas. For example, when the respective axis is divided into three sections, the plane is divided into nine areas in total. As the value on the x axis increases, the geographical environment of the wireless channel of the mobile terminal 40 or 40′ becomes better, and as the value on the y axis decreases, the wireless channel environment according to the mobility of the mobile terminal 40 or 40′ becomes better. That is, the wireless channel environment of the mobile terminal 40 or 40′ becomes better as the values on the x axis increases and the value on the y axis decreases. If a number is assigned to each of the nine areas according to the wireless channel environment thereof, numbers 1 to 5 can be assigned to the areas as shown in FIG. 10, wherein the wireless channel environment of the respective areas becomes better as the number assigned thereto decreases.

In this manner, the channel evaluation unit 320 of channel estimation apparatus 300 estimates the overall wireless channel environment of the mobile terminal 40 or 40′ by using the plane in FIG. 10. Thereafter, the base station 30 can easily perform wireless resource assignment, handover, scheduling, and the like without consuming limited resources of the mobile terminal 40 or 40′ by using the estimation result.

An example where the channel estimation apparatus and method in accordance with the present invention are applied to the HSDPA system, which is a representative third-generation mobile communication system, will be described.

The HSDPA system includes a base station 30 and mobile terminals 40, as shown in FIGS. 7A and 7B, and thirty CQI values are defined to represent the channel environment parameter. The thirty CQI values are sorted based on the data rate and they range from 1 to 30.

The channel estimation apparatus 300 is installed in the base station 30 or separately provided therefrom. The channel estimation apparatus 300 includes the average measurement unit 310 for measuring the average value of CQI, the normalization unit 330 for normalizing the CQI, the LCR measurement unit 340 for measuring the LCR of the normalized CQI, and the channel evaluation unit 320. W is set to 1000, W being the window size 301 in measuring the weighted moving average. Since one TTI (Transmission Time Interval) is set to 2 ms in the HSDPA, feedback values during recent two seconds are measured. Further, L is set to 0.5, L being a threshold value 302 in measuring the LCR, to thereby measure the number of times when the feedback signal strength weaker than half of its average value increases to be stronger than half of its average value. The wireless channel environment of each mobile terminal 40 can be estimated by confirming one of the nine areas of FIG. 10 to which the mobile terminal belongs, based on the measured average value and the LCR.

An example, where the channel estimation apparatus and method in accordance with the present invention are applied to a portable Internet system such as the WiBro system, will be described.

The WiBro system includes a base station 30 and mobile terminals 40′, as shown in FIGS. 8A and 8B. Unlike the HSDPA system, the mobile terminal transmits, as a feedback signal, the measured SINR value instead of the channel environment parameter in the WiBro system.

The channel estimation apparatus 300 is installed in the base station 30 or separately provided therefrom. The channel estimation apparatus 300 includes the average measurement unit 310 for measuring the average value of SINR, the normalization unit 330 for normalizing the SINR, the LCR measurement unit 340 for measuring the LCR from the normalized SINR, and the channel evaluation unit 320. W and L are set to 1000 and 0.5, respectively, W being the window size 301 in measuring the weighted moving average and L being the threshold value 302 in measuring the LCR. The wireless channel environment of each mobile terminal 40′ can be estimated by confirming one of the nine areas of FIG. 10 to which each mobile terminal belongs, based on the measured average value and the LCR value.

Until now, configuration and operation of the channel estimation apparatus in accordance with the present invention have been described through various embodiments shown in FIGS. 4A to 10. The channel estimation apparatus described until now estimates the wireless channel environment by using the feed back signals received from the mobile terminals 40 or 40′, wherein the base station 30 transmits a pilot signal 35 as an example of the channel state indication signal.

However, the channel estimation apparatus can obtain information on wireless channel environment by using a pilot signal received from the mobile terminals 40 or 40′, the pilot signal not being a feedback signal. Further, the channel estimation apparatus can be installed at each mobile terminal 40 or 40′.

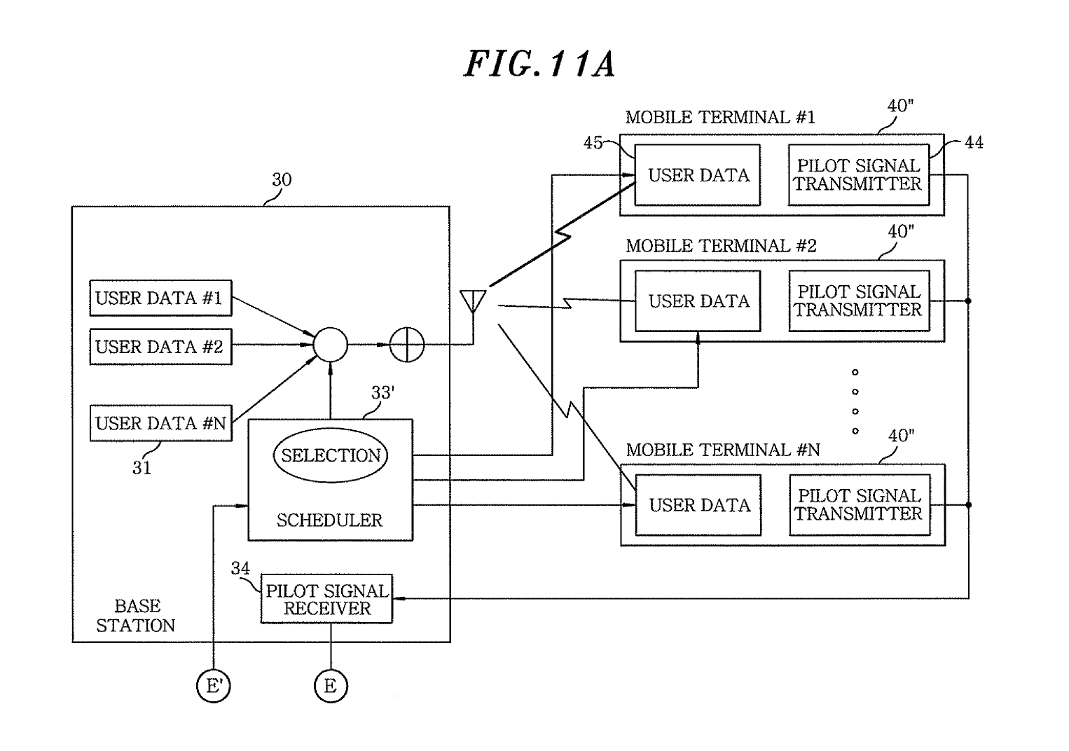

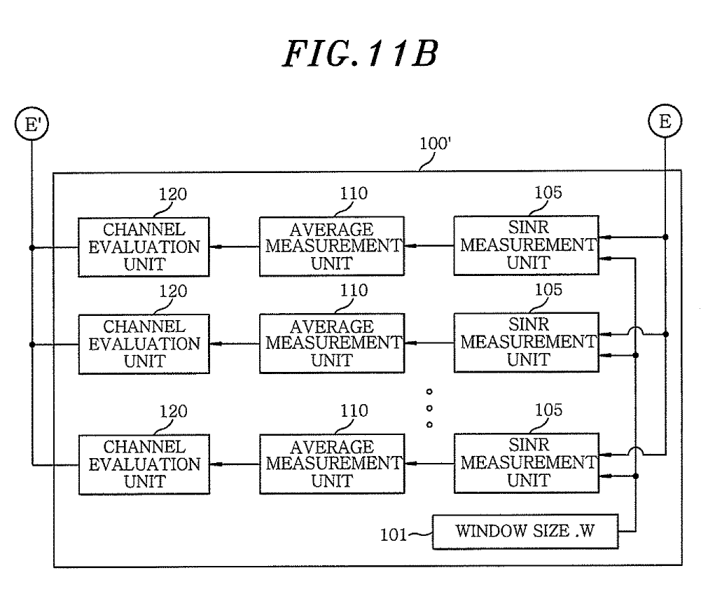

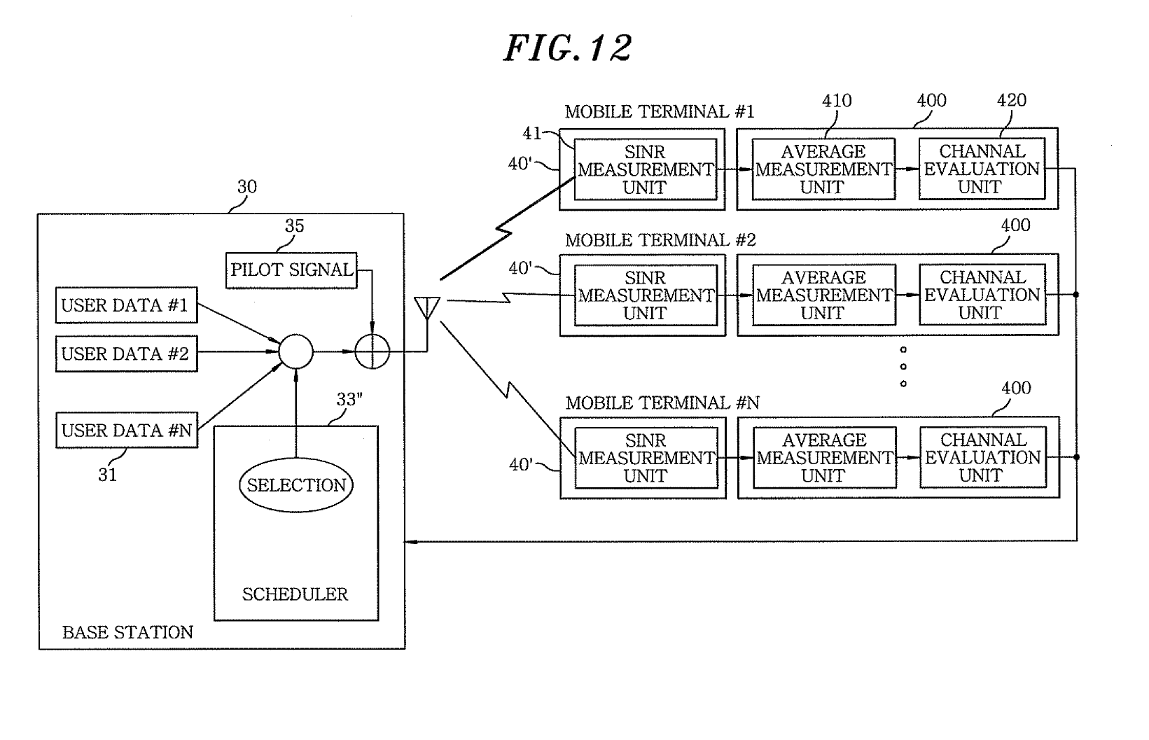

FIGS. 11A to 12 illustrate a channel estimation apparatus 100′ and 400 in accordance with the above-described embodiments, respectively. Though FIGS. 11A to 12 are modifications of FIGS. 5A and 5B, the following descriptions on FIGS. 11A to 12 can be applied to FIGS. 4A, 4B, 7A, 7B, 8A and 8B.

A mobile terminal 40″ shown in FIGS. 11A and 11B includes a pilot signal transmitter 44 for transmitting its pilot signal to the base station 30. The pilot signal generated and transmitted by the pilot signal transmitter 44 in each mobile terminal 40″ is received by a pilot signal receiver 34 in the base station 30.

The received pilot signal is sent to the SINR measurement unit 105 in the channel estimation apparatus 100′ installed at the base station 30, and then the SINR measurement unit 105 measures the SINR values of the pilot signal received from each mobile terminal 40″.

The average measurement unit 110 and the channel evaluation unit 120 estimates the characteristics of the wireless channels relating to each mobile terminal 40″ by using the measured SINR values, and then the wireless channel environment information is sent to the scheduler 33′.

The scheduler 33′ performs uplink and downlink traffic scheduling by using the wireless channel environment information received from the channel evaluating unit 120. First, for downlink traffic scheduling, the scheduler 33′ selects one of queues 31 arranged at the base station 30 to transmit downlink frames stored in the selected queue 31 to the corresponding mobile terminal 40″. On the other hand, with reference to the wireless channel environment information, the scheduler 33′ can select a mobile terminal 40″ to which uplink frames are to be transmitted next to the mobile terminal 40″ being served presently. In this case, the base station 30 transmits an uplink frame transmit request to the selected mobile terminal 40″ to make uplink frames transmitted from a queue 45 at the corresponding mobile terminal 40″ to the base station 30.

In case of channels in TDD (Time Division Duplex) system, wherein channel characteristics of uplink and downlink are identical or at least one of them can be inferred from the other, wireless channel environment information can be used in scheduling both of the uplink and downlink traffic. However, the present invention can be also applied to the case where the wireless channel environment information is used for scheduling either the uplink or the downlink traffic.

The channel estimation apparatus 100′ in this embodiment estimates the characteristics of the wireless channel by using the pilot signal, instead of the feedback signal, received from the mobile terminal 40″, thereby simplifying a signal exchange cycle relating to a network scheduling. Therefore, fast scheduling can be realized.

On the other hand, FIG. 12 illustrates a case where the channel estimation apparatus 400 is installed at the mobile terminal 40′. The channel estimation apparatus 400 in FIG. 12 measures the weighted moving average of the SINR values of the pilot signals received from the SINR measuring unit 41 of the mobile terminal 40′, and then sends the measured average value to the channel evaluation unit 420 to generate the wireless channel environment information to be transmitted to the base station 30. The wireless channel environment information transmitted by the channel estimating apparatus 400 at the mobile terminal 40′ is utilized in selecting a mobile terminal 40′ to be served next to the mobile terminal 40′ being served by the scheduler 33″ of the base station 30.

The average measurement unit 410 and the channel evaluation unit 420 included in the channel estimation apparatus 400 in FIG. 12 have substantially similar functions as those of the average measurement unit 110 and the channel evaluation unit 120 in FIGS. 5A and 5B.

In case a scheduling scheme capable of predicting the characteristics of vector channels is required to be performed in an OFDM (Orthogonal Frequency Division Multiplexing) or a MIMO (Multi Input Multi Output) antenna system, the channel estimation apparatus 400 in FIG. 12 reduces the amount of information fed back to the scheduler 33″, thus decreasing the load due to the feedback process. Accordingly, a fast scheduling scheme can be achieved.

As described above, in accordance with the present invention, by using channel state indication signal, the overall wireless channel environment according to both of the geographical environment and the mobility can be estimated. Since the estimated overall wireless channel environment is utilized by the base station and the mobile terminal, scheduling accuracy can be improved in comparison with the conventional case in which the estimation result is utilized by the mobile switching center, thereby improving transmission efficiency in the mobile communication system.

In addition, the mobile terminals are not required to provide information indicating the wireless channel environment, thereby preventing additional power consumption in the mobile terminals.

While the invention has been shown and described with respect to the embodiments, it will be understood by those skilled in the art that various changes and modifications may be made without departing from the scope of the invention as defined in the following claims.

What is claimed is:

1. A channel estimation apparatus, wherein channel state indication signals are transmitted to communication stations via wireless channels and SINR (Signal to Interference and Noise Ratio) values of the channel state indications signals or channel environment parameters according to the SINR values are received from the communication stations as feedback signals, the apparatus comprising:
an average measurement unit for measuring average values of the feedback signals over a period of time, each of the average values being an average value of feedback signals received from an identical communication station during the period of time; and
a channel evaluation unit for estimating wireless channel quality of each communication station according to a geographical environment thereof based on the average values measured by the average measurement unit.

2. The channel estimation apparatus of claim 1, wherein each of the channel state indication signals is a pilot signal.

3. The channel estimation apparatus of claim 1, wherein each average value measured by the average measurement unit is a weighted moving average with a specific window size.

4. The channel estimation apparatus of claim 3, wherein the average measurement unit assigns a higher weight to the feedback signal received more recently.

5. The channel estimation apparatus of claim 1, wherein the channel evaluation unit divides a range of the average values measured by the average measuring unit into a plurality of sections, and uses each section as an index indicating the wireless channel quality according to the geographical environment.

6. The channel estimation apparatus of claim 1, wherein the channel environment parameter as a feedback signal is used in determining a coding rate and modulation scheme for data transmission.

7. The channel estimation apparatus of claim 6, wherein the channel environment parameter represents one of an MCS (Modulation and Coding Scheme) value, a CQI (Channel Quality Indicator) value, and a DRC (Data Rate Control) value.

8. The channel estimation apparatus of claim 1, further comprising:
a normalization unit for normalizing the respective feedback signals by using the average values measured by the average measurement unit; and
an LCR (Level Crossing Rate) measurement unit for measuring LCR values of the feedback signals,
wherein the channel evaluation unit additionally estimates the wireless channel quality of each communication station according to a mobility thereof based on the LCR values measured by the LCR measuring unit.

9. The channel estimation apparatus of claim 1, wherein the channel evaluation unit divides a range of the LCR values measured by the LCR measuring unit into a plurality of sections and uses each section as an index indicating the wireless channel quality according to the mobility.

10. The channel estimation apparatus of claim 8, wherein the channel evaluation unit estimates an overall channel environment by using the estimation result of the wireless channel quality according to the geographical environment and the estimation result of the wireless channel quality according to the mobility.

11. A channel estimation apparatus, comprising:
an average measurement unit for measuring an average value of pilot signals over a period of time, the pilot signals being SINR (Signal to Interference and Noise Ratio) values of channel state indication signals received from a communication station via a wireless channel during the period of time or channel environment parameters according to the SINR values; and
a channel evaluation unit for estimating wireless channel quality according to a geographical environment based on the average values measured by the average measurement unit.

12. The channel estimation apparatus of claim 11, further comprising:
an LCR (Level Crossing Rate) measurement unit for normalizing the respective pilot signals by using the average values measured by the average measuring unit, and measuring LCR values of the normalized pilot signals,
wherein the channel evaluation unit additionally estimates the wireless channel quality according to a mobility based on the LCR values measured by the LCR measuring unit.

13. The channel estimation apparatus of claim 12, wherein the channel evaluation unit estimates an overall channel environment by using the estimation result of the wireless channel quality according to the geographical environment and the estimation result of the wireless channel quality according to the mobility.

14. A channel estimation method, wherein channel state indication signals are transmitted to communication stations via wireless channels and SINR (Signal to Interference and Noise Ratio) value of the channel state indications signals or channel environment parameters according to the SINR values are received from the communication stations as feedback signals, the method comprising the steps of:
(a) measuring average values of feedback signals over a period of time, each being an average value of feedback signals received from an identical communication station during the period of time; and
(b) estimating wireless channel quality of each communication station according to a geographical environment thereof based on the average values measured in step (a).

15. The channel estimation method of claim 14, wherein each of the channel state indication signal is a pilot signal.

16. The channel estimation method of claim 14, wherein each average value measured in step (a) is a weighted moving average with a specific window size.

17. The channel estimation method of claim 16, wherein, in step (a), a higher weight is assigned to the feedback signal received more recently.

18. The channel estimation method of claim 14, wherein, in step (b), a range of the average values measured in step (a) is divided into a plurality of sections, and uses each section as an index indicating the wireless channel quality according to the geographical environment.

19. The channel estimation method of claim 14, wherein the channel environment parameter as a feedback signal is used in determining a coding rate and modulation scheme for data transmission.

20. The channel estimation method of claim 19, wherein the channel environment parameter represents one of an MCS (Modulation and Coding Scheme) value, a CQI (Channel Quality Indicator) value, and a DRC (Data Rate Control) value.

21. The channel estimation method of claim 14, further comprising:
(c) normalizing the respective feedback signals by using the average values measured in step (a), and measuring LCR (Level Crossing Rate) values of the feedback signals,
wherein, in step (b), the wireless channel quality of each communication station according to a mobility thereof is additionally estimated based on the LCR values measured in step (c).

22. The channel estimation method of claim 21, wherein, in step (b), a range of the LCR values measured in step (c) is divided into a plurality of sections and uses each section as an index indicating the wireless channel quality according to the mobility.

23. The channel estimation method of claim 21, wherein in step (b), an overall channel environment is estimated by using the estimation result of the wireless channel quality according to the geographical environment and the estimation result of the wireless channel quality according to the mobility.

24. A channel estimation method, comprising the steps of:
(a) measuring an average value of pilot signals over a period of time, the pilot signals being SINR (Signal to Interference and Noise Ratio) values of channel state indication signals received from a communication station via a wireless channel during the period of time or channel environment parameters according to the SINR values; and
(b) estimating wireless channel quality according to a geographical environment based on the average values measured in step (a).

25. The channel estimation method of claim 24, further comprising:
(c) normalizing the respective pilot signals by using the average values measured by the average measuring unit, and measuring LCR values of the normalized pilot signals,
wherein, in step (b), the wireless channel quality according to a mobility is additionally estimated based on the LCR values measured in step (c).

26. The channel estimation method of claim 25, wherein, in step (b), an overall channel environment is estimated by using the estimation result of the wireless channel quality according to the geographical environment and the estimation result of the wireless channel quality according to the mobility.
